(19) United States
(12) Patent Application Publication
(10) Pub. No.: US 2026/0087058 A1
(43) Pub. Date: Mar. 26, 2026

(54) SYSTEM AND METHOD FOR TEXT MINING AND CLASSIFICATION

(71) Applicants: Ashuvendra Pratap Singh, Edison, NJ (US); Abhishek Mittal, Clark, NJ (US); Rajiv Arora, Katy, TX (US); Pooja Srivastava, Shrewsbury, MA (US); Rohan Pimprikar, Jersey City, NJ (US); Tamica Butler, San, TX (US)

(72) Inventors: Ashuvendra Pratap Singh, Edison, NJ (US); Abhishek Mittal, Clark, NJ (US); Rajiv Arora, Katy, TX (US); Pooja Srivastava, Shrewsbury, MA (US); Rohan Pimprikar, Jersey City, NJ (US); Tamica Butler, San, TX (US)

(21) Appl. No.: 18/891,389

(22) Filed: Sep. 20, 2024

(51) Int. Cl. G06F 16/35; G06F 40/284

(52) U.S. Cl. CPC G06F 16/35; G06F 40/284

(57) ABSTRACT

Systems and methods for classifying incoming electronic messages are disclosed. An incoming message having a first text field containing sender identifying information, a second text field containing a subject, and a third text field containing a body is received. The message is characterized based on the sender identifying information when that information is sufficient. Upon a determination that the incoming message cannot be categorized based on the sender identifying information, the second text field and the third text field of the message are tokenized into a plurality of textual units and vectorized into numerical representations for analysis and pattern recognition. The vectorizing includes using the natural language processing model to evaluate words and sentence embeddings to determine a relative importance. The vectorized textual units are evaluated, using a machine learning model, to classify the incoming message into a classification having a case reason and a case topic.

### TECHNICAL FIELD

This application relates generally to text classification, and more particularly, to automatically classifying incoming messages, such as e-mail messages.

### BACKGROUND

In some organizations, incoming text based messages, e.g. electronic mail (“e-mail”) messages, are received at a centralized repository, such as a database, and then are evaluated to determine which team member, or group of team members, should handle the email by responding or acting upon its contents.

In a setting such as a large organization, an e-mail may be received and then pushed to a database that handles e-mails and other communications with customers, such as Salesforce. A case may then be created from the email, and the e-mail my then be reviewed by one or more human validators, who manually read the email, and categorize it based on its contents, so that it can be assigned to the appropriate person or people for resolution. Some e-mail categories may include new order requests, renewal order requests, order cancelations, IT access requests, etc. The human validator or validators may assign a category to an e-mail, and based on the manually assigned category, the email may then be assigned to a particular team to handle the case.

This manual intensive process presents a number of problems and inefficiencies, especially in organizations and systems that have a large volume of cases where a highly manual process which is also a highly subjective process relying on the experience of the human validator.

### SUMMARY

In various embodiments, a system for automatically categorizing an incoming electronic message using natural language processing to generate an input for a machine learning classification model is disclosed. The system includes a non-transitory memory and a processor communicatively coupled to the non-transitory memory. The processor is configured to read a set of instructions to receive an incoming message. The incoming message has a first text field containing sender identifying information, a second text field containing a subject, and a third text field containing a body. The processor is further configured to determine whether the incoming message can be categorized based on the sender identifying information and, upon a determination that the incoming message can be categorized based on the sender identifying information, categorize the incoming message based on the sender identifying information. Upon a determination that the incoming message cannot be categorized based on the sender identifying information, the processor is configured to tokenize the second text field and the third text field into a plurality of textual units and vectorize, by a natural language processing model, the plurality of textual units into numerical representations for analysis and pattern recognition. The vectorizing includes using the natural language processing model to evaluate words and sentence embeddings to determine a relative importance. The processor is further configured to evaluate the vectorized textual units, using a machine learning model, to classify the incoming message into a classification having a case reason and a case topic.

In various embodiments, a computer-implemented method for automatically categorizing an incoming electronic message using natural language processing to generate an input for a machine learning classification model is disclosed. The method includes a step of receiving an incoming message. The incoming message has a first text field containing sender identifying information, a second text field containing a subject, and a third text field containing a body. The method further includes steps of determining whether the incoming message can be categorized based on the sender identifying information and, upon a determination that the incoming message can be categorized based on the sender identifying information, categorizing the incoming message based on the sender identifying information. Upon a determination that the incoming message cannot be categorized based on the sender identifying information, the method includes steps of tokenizing the second text field and the third text field into a plurality of textual units and vectorizing, by a natural language processing model, the plurality of textual units into numerical representations for analysis and pattern recognition. The vectorizing includes using the natural language processing model to evaluate words and sentence embeddings to determine a relative importance. The method includes a step of evaluating the vectorized textual units, using a machine learning model, to classify the incoming message into a classification having a case reason and a case topic.

In various embodiments, non-transitory computer readable medium having instructions stored thereon for automatically categorizing an incoming electronic message using natural language processing to generate an input for a machine learning classification model is disclosed. The instructions, when executed by at least one processor, cause at least one device to perform operations including receiving an incoming message. The incoming message has a first text field containing sender identifying information, a second text field containing a subject, and a third text field containing a body. The operations further include determining whether the incoming message can be categorized based on the sender identifying information and, upon a determination that the incoming message can be categorized based on the sender identifying information, categorizing the incoming message based on the sender identifying information. Upon a determination that the incoming message cannot be categorized based on the sender identifying information, the operations further include tokenizing the second text field and the third text field into a plurality of textual units and vectorizing, by a natural language processing model, the plurality of textual units into numerical representations for analysis and pattern recognition. The vectorizing includes using the natural language processing model to evaluate words and sentence embeddings to determine a relative importance. The operations include evaluating the vectorized textual units, using a machine learning model, to classify the incoming message into a classification having a case reason and a case topic.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a network environment configured to provide system and method for classifying incoming messages, in accordance with some embodiments;

FIG. 2 illustrates a computer system configured to implement one or more processes, in accordance with some embodiments;

FIG. 3 is a flowchart illustrating a method for classifying incoming messages, in accordance with some embodiments;

FIG. 4 is a block diagram of a machine learning classification model in accordance with one aspect of the present disclosure.

FIG. 5 is a flow diagram of a workflow for delivery, maintenance and usage, in accordance with one aspect of the present disclosure.

FIG. 6A illustrates an artificial neural network, in accordance with some embodiments;

FIG. 6B illustrates a tree-based artificial neural network, in accordance with some embodiments;

FIG. 6C illustrates a deep neural network (DNN), in accordance with some embodiments;

FIG. 7A is a flowchart illustrating a training method for generating a trained machine learning model, in accordance with some embodiments; and

FIG. 7B is a process flow illustrating various steps of the training method of FIG. 7A, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for classifying incoming messages. In various embodiments, systems and methods for classifying incoming messages receive an incoming message having one or more text fields, such as a first text field containing sender identifying information, a second text field containing a subject, and a third text field containing a body. In some embodiments, an incoming message may be classified based on sender identifying information. When a message cannot be classified based on sender identifying information, one or more text fields, such as the second text field and/or the third text field, are tokenized into a plurality of textual units. A natural language processing model is applied to vectorize the plurality of textual units into numerical representations for analysis and pattern recognition. The natural language processing model evaluates words and/or sentence embeddings to determine a relative importance. A trained machine learning model, such as the natural language processing model and/or a separately trained machine learning model, may classify the incoming message. The classification of the incoming message may have a case reason and/or a case topic. A probability that the incoming message has been classified correctly may be calculated and, when the probability is below a predetermined threshold, the incoming message may be tagged further evaluation of the classification. When the probability is above the predetermined threshold, the incoming message may be forwarded to an appropriate process and/or repository for further action relating to the classification.

In some embodiments, systems, and methods for system and method for classifying incoming messages includes one or more trained machine learning (“ML”), artificial intelligence (“AI”), and/or natural language processing (“NLP”) models. The trained models may include one or more models, such as system and method for classifying incoming messages.

In general, a trained function mimics cognitive functions that humans associate with other human minds. In particular, by training based on training data the trained function is able to adapt to new circumstances and to detect and extrapolate patterns. In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

In some embodiments, a trained function may include a neural network, a support vector machine, a decision tree, a Bayesian network, a clustering network, Qlearning, genetic algorithms and/or association rules, and/or any other suitable artificial intelligence architecture. In some embodiments, a neural network may be a deep neural network, a convolutional neural network, a convolutional deep neural network, etc. Furthermore, a neural network may be an adversarial network, a deep adversarial network, a generative adversarial network, etc.

In various embodiments, neural networks which are trained (e.g., configured or adapted) to generate classifications, are disclosed. A neural network trained to generate classifications may be referred to as a classification model. A classification model may be configured to receive a set of input data, e.g. tokenized incoming messages, and generate an output, e.g., a classification.

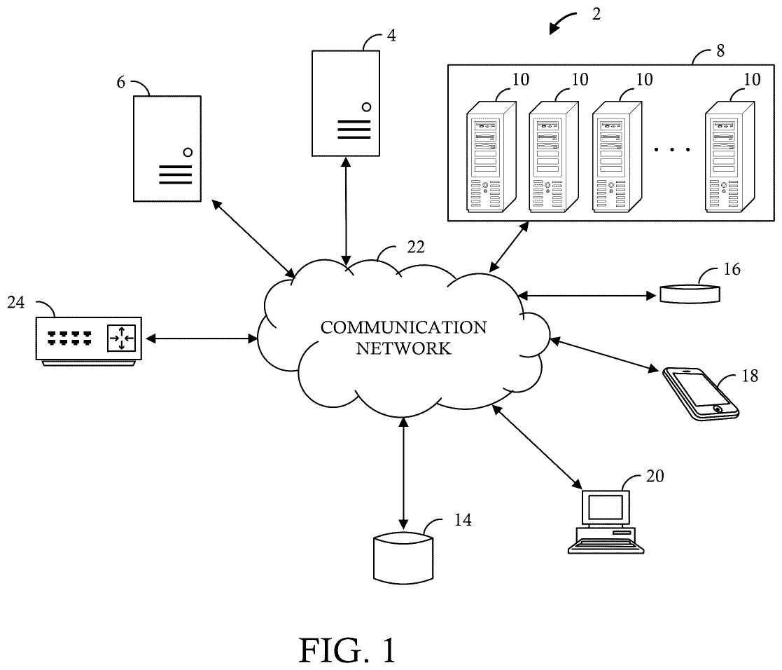

FIG. 1 illustrates a network environment 2 configured to provide system and method for classifying incoming messages, in accordance with some embodiments. The network environment 2 includes a plurality of devices or systems configured to communicate over one or more network channels, illustrated as a network cloud 22. For example, in various embodiments, the network environment 2 may include, but is not limited to, a message classification computing device 4, a web server 6, a cloud-based engine 8 including one or more processing devices 10, a database 14, and/or one or more user computing devices 16, 18, 20 operatively coupled over the network 22. The message classification computing device 4, the web server 6, the processing device(s) 10, and/or the user computing devices 16, 18, 20 may each be a suitable computing device that includes any hardware or hardware and software combination for processing and handling information.

In some embodiments, each of the message classification computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the message classification computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an electronic communication network environment. In some embodiments, the message classification computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

Although FIG. 1 illustrates three user computing devices 16, 18, 20, the network environment 2 may include any number of user computing devices 16, 18, 20. Similarly, the network environment 2 may include any number of the message classification computing device 4, the web server 6, the processing devices 10, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the message classification computing device 4, the web server 6, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the user computing devices 16, 18, 20 may communicate with the web server 6 over the communication network 22. For example, each of the user computing devices 16, 18, 20 may be operable to transmit electronic messages to and/or receive electronic messages from the web server 6. The web server 6 may forward received electronic communications to the message classification computing device 4 over the communication network 22.

In some embodiments, the message classification computing device 4 may execute one or more models, processes, or algorithms, such as a machine learning model, deep learning model, statistical model, etc., to classify incoming messages. The message classification computing device 4 is further operable to communicate with the database 14 over the communication network 22. For example, the message classification computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the message classification computing device 4, in some embodiments, the database 14 may be a local storage device, such as a hard drive, a non-volatile memory, or a USB stick. The message classification computing device 4 may store interaction data received from the web server 6 in the database 14. The message classification computing device 4 may also receive from the web server 6 user session data identifying events associated with browsing sessions, and may store the user session data in the database 14.

In some embodiments, the message classification computing device 4 generates training data for a plurality of models (e.g., machine learning models, deep learning models, statistical models, algorithms, etc.) based on tagged textual communication data, predetermined category classifications, etc. The message classification computing device 4 and/or one or more of the processing devices 10 may train one or more models based on corresponding training data. The message classification computing device 4 may store the models in a database, such as in the database 14 (e.g., a cloud storage database).

The models, when executed by the message classification computing device 4, allow the message classification computing device 4 to classify incoming messages. For example, the message classification computing device 4 may obtain one or more models from the database 14. The message classification computing device 4 may then receive, in real-time from the web server 6, a incoming messages. In response to receiving incoming messages, the message classification computing device 4 may execute one or more models for classifying incoming messages and output a message classification. The message classification may be provided to the server 6, the database 14, and/or any other suitable system to cause forwarding and/or further processing of one or more electronic communications based on the message classification.

In some embodiments, the message classification computing device 4 assigns the models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, message classification computing device 4 may generate classification outputs.

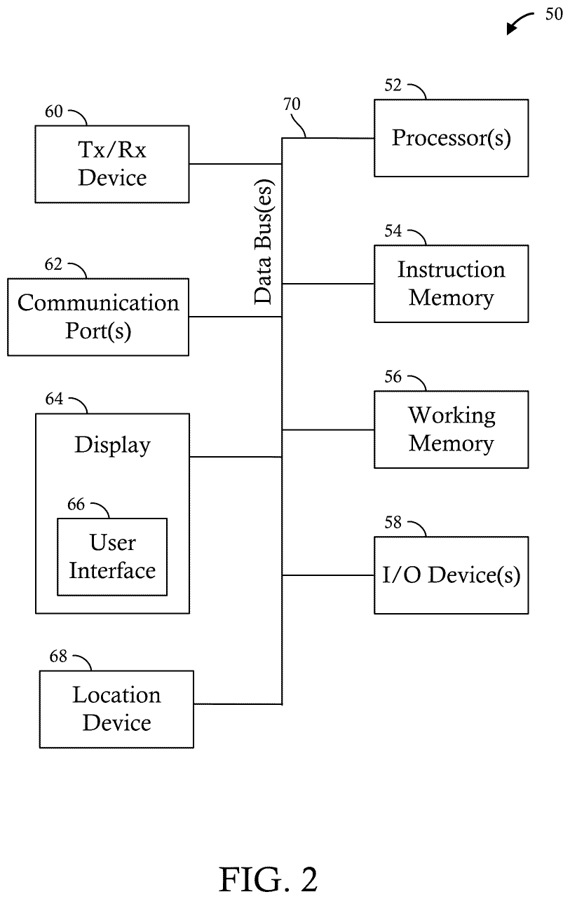

FIG. 2 illustrates a block diagram of a computing device 50, in accordance with some embodiments. In some embodiments, each of the message classification computing device 4, the web server 6, the one or more processing devices 10, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for classifying incoming messages, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with a system and method for classifying incoming messages. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

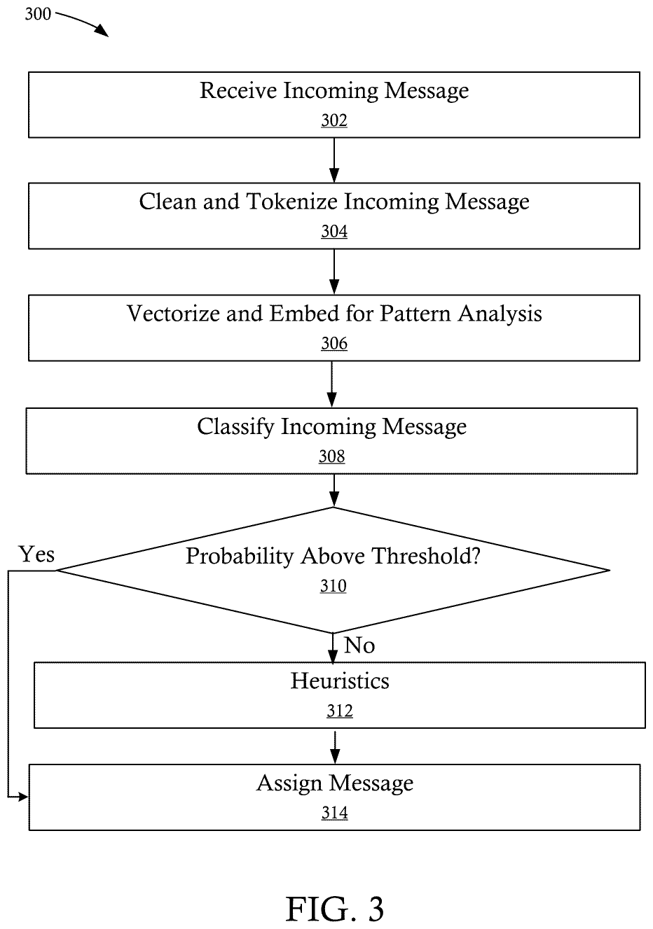

FIG. 3 is a flowchart illustrating a method 300 for classifying incoming messages, in accordance with some embodiments. The method 300 uses machine learning model, trained by a historical data set of previously categorized emails, including the email content itself and an ultimate categorization decision.

At step 302, an electronic communication (e.g., e-mail) is received. After receipt of the electronic communication, a cleaning and tokenization step 304 is executed. Cleaning and tokenization step 304 converts the text data, e.g. from the email subject and body, into meaningful units for further analysis. For example, in some embodiments, a tokenization process is configured to convert sentences, words, characters (e.g., letters numbers, punctuation, etc.) of the received electronic communication into computer-readable tokens. The tokenization process may be based on a domain-specific tokenization lexicon or dictionary configured to provide tokenization of terms within an expected domain (or a set of expected domains) related to the electronic communication.

At step 306, the text units, e.g., tokens, created in cleaning and tokenization step 304 are converted into machine-readable embeddings (e.g., vectors). The generated embeddings may include numerical representations indicative of an evaluation of the relative importance of the segment to the categorization process. Term Frequency-Inverse Document Frequency (“TF-IDF”) models may be used in vectorization step 306. Term Frequency is the relative frequency of a term within a document. Inverse document frequency uses a function of how many documents in a universe contain a term, which the present document contains, as a measure of the importance of the term.

By way of example, the system may receive an e-mail that containing the phrase “cancel the meeting,” along with other body text and subject text. “Cancel the meeting” would first be identified as a unitary phrase, via cleaning and tokenization step 304, and then analyzed for importance at vectorization step 306.

Machine learning is then used at classification step 308, to categorize emails based on the vectorized content created in vectorization step 306. Classification step 308 includes machine learning models, which may include AI and/or NLP models. By way of example, XGBoost Deep Learning algorithms may be used. Classification step 308 uses the machine learning models to classify the message with a classification and a sub-classification. A classification may also be referred to as a “reason,” and a subclassification may also be referred to as a “topic.”

When a probability of a correct classification is below a threshold (310), Heuristics 312 may also be used after classification step 308. Heuristics may be more manually intensive, and, in some embodiments, may only be used on some messages and not on others. In some embodiments, classification step 308 may include a determination of a probability that the classification is correct, and may also include a probability that the subclassification is correct. In some embodiments, emails may be classified, without heuristics, when either the probability that the classification is correct, or the probability that the subclassification is correct, or both, are above a predetermined threshold. In those embodiments, heuristics may be employed when one or both of those probabilities is below the predetermined threshold. After heuristics are applied, the incoming message may then be assigned 314. If probability of a correct classification after step 308 was above a threshold, heuristics 312 may not be applied, and the message may be assigned 314. Limiting application of heuristics to only those messages having a probability below a predetermined threshold improves operation of the underlying system by reducing the use of computing resources (e.g., requiring only application of the trained machine learning models for the majority of classifications), decreasing the classification time, and providing higher accuracy in classifications.

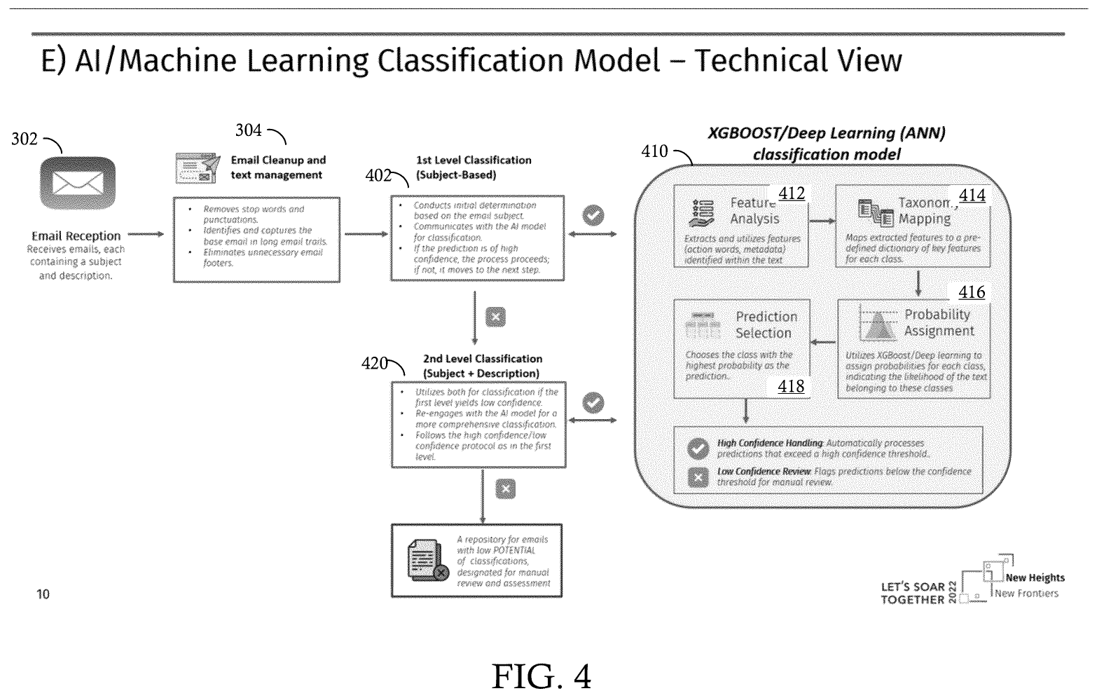

FIG. 4 is a block diagram of a machine learning classification model 400, as may be used in classification step 308 of FIG. 3, in accordance with one aspect of the present disclosure. As discussed above with reference to FIG. 3, the model receives an electronic communication (302). The model may first analyze a sender field of the message, to determine, based on rules, whether the email can be categorized, sufficient for substantive handling, using the sender information alone.

If the sender-only analysis is not successful at categorizing the electronic communication, the model may remove (304) text and/or other elements from the email that are not useful in classification of the electronic communication, e.g., elements the model considers to be noise. Noise may include, but is not limited to, punctuations, repetitive words, extraneous words such as “the,” “so,” and the like, etc. What remains after cleaning and tokenization 304 is a corpus of words and/or phrases that may be tokenized and/or sorted into textual units.

The corpus of textual units is then passed to a multi-level classification process. The first level of classification 402 may be subject-based. In first level classification 402, the message is analyzed to determine whether the subject alone is suggestive enough of what category that e-mail would lie in, such that no further categorization would be necessary. So for example, as discussed above, a message requesting the cancelation of a meeting, may include that information in the subject itself. In that instance, with a subject line sufficiently suggestive of an electronic communication category, more data is not generally necessary, and the electronic communication may be categorized without further analysis of the body text. Subject based analysis may include sending textual units, from the subject only, to classification model 410, which will be discussed in further detail below. In some embodiments, classification model 410 may return a confidence probability, which may then be compared to a confidence probability threshold to determine whether subject-based analysis is sufficient for classification 402, or whether analysis of the body text is necessary.

If body text analysis is deemed necessary, additional textual units may be sent to classification model 410, including units from both the subject of the electronic communication and the body text. Using these textual units is more resource intensive but may also provide for more comprehensive classification.

Accordingly, textual units are sent to classification model 410. As described above, some iterations of classification model 410 may act on only the subject, while others may act on textual units from both the subject and the body.

The first part of classification model 410 may include feature analysis 412, wherein the words and the sentences within the passed content that capture the essence of that electronic communication may be identified.

In some embodiments, taxonomy mapping 414 follows feature analysis 412. Taxonomy mapping 414 may include words that are repetitive in multiple electronic communication of the same kind. A dictionary of action words or sentences may be created and used, and compared to electronic communication tags that similar words or sentences have received historically. Accordingly, a rule base is created, wherein certain words, fragments, and sentences may be identified, and the context in which these are used, as well as the semantics around them, may also be identified. For example, as previously discussed, an email may contain a sentence that mentions creating or canceling a meeting. Analysis of historical records of emails containing that sentence and similar sentences may result in the creation of a dictionary, which may result in a rule, informed by prior experience and previous classification, on how the electronic communication should be classified.

Probability assignment 416 may then be performed. In probability assignment 416, machine learning models utilizes deep learning and XGBoost to assign probabilities for each class, indicating the likelihood of the text belonging to a class. For some electronic communication the classification may be very clear based on the content, but for others another layer may be needed to assign it to a particular class. After probability assignment 416, the electronic communication may ultimately be classified into the class in which it has the highest probability of classification, which may occur via prediction selection 418. Thus the output of the model includes a classification and a probability that the classification is correct.

A threshold for probability may be used to determine whether a classification result is high confidence or low confidence. In some embodiments, to maintain the highest degrees of accuracy, a high probability threshold may be used. In other embodiments, efficiency may take on a greater degree of importance and a lower threshold may be used.

Accordingly, for each message, classification model 410 may be iterated twice. First, it may be iterated on the subject of the electronic communication only. If this is determined to yield a high confidence classification, the analysis may end there, and the classification may be associated with the electronic communication for further handling. If running classification model 410, on the subject only, is determined to yield a low confidence classification, then classification model 410 may be run again, on both the subject and the body 420.

As discussed above, TF-IDF may be used as a basic approach of determining which words within the electronic communication are the best indicator of the essence of the electronic communication. Sentence embedding may also be used in classification model 410. Sentence embedding is a more advanced approach that captures not only individual words, but also the sentences and the semantics around a word or a set of words being used. So for a simple example of sentence embedding, consider a sentence “the apple is on a table,” and another sentence “the table has an apple on it.” Sentence embedding would tag each of these as being the same sentence, after analyzing the context and semantics of each and boiling them down to their core meanings. Accordingly, the machine learning model uses a twofold approach, utilizing just the subject first, and then turning to as well as the subject plus the body if needed.

In instances where the classification of electronic communications was not at a high enough confidence level, despite having this robust approach, a heuristic layer may also be used as a backup. Similarly, in some embodiments, human experts may be employed to classify certain electronic communication that are not successfully classified by the trained model and/or the heuristic process.

In some embodiments, text features may be used. When heavy text is managed by an AI modeling perspective, it may be important to understand contextual themes conveyed by different keywords. Combinations of keywords, and the position of keywords within the text, might also convey clues or other information about the categorization of the whole text. Also, the same keyword can indicate one categorization when surrounded by a first set of additional keywords, and a different categorization when surrounded by a second set of additional keywords. In some embodiments, a taxonomy may be used or updated with the sets of keywords.

By way of example, a keyword such as “account” may be associated, e.g. via an AI model, with electronic communication requesting a password reset because a user is unable to access his or her account, if it is accompanied by words such as “reset” or “unable.” However, the keyword “account” may be associated with a request for a new account, when accompanied by other keywords such as “access” or “setup.”

In some embodiments, the model may return number or other value indicating a level of confidence in its own prediction. The confidence level may be compared to a threshold confidence level, which may then be used to determine whether the classification is reviewed manually before assignment, or is directly assigned to an end user associated with handling messages of that classification type. In some embodiments, a confidence level of 90% or 95% may be used as a threshold. In some embodiments, a feedback loop, which may include the results of a model-based classification, a heuristic-based classification, and/or a manual review may be used to generate feedback data for revising or retraining the classification model. For example, outputs of the classification model that are re-tagged (either through heuristic or manual processes) may be provided as additional training data for retraining of a classification model. Successful classifications, i.e., classifications by the classification model that are not reclassified, may similarly be included in additional training data for revising and/or retraining the classification model.

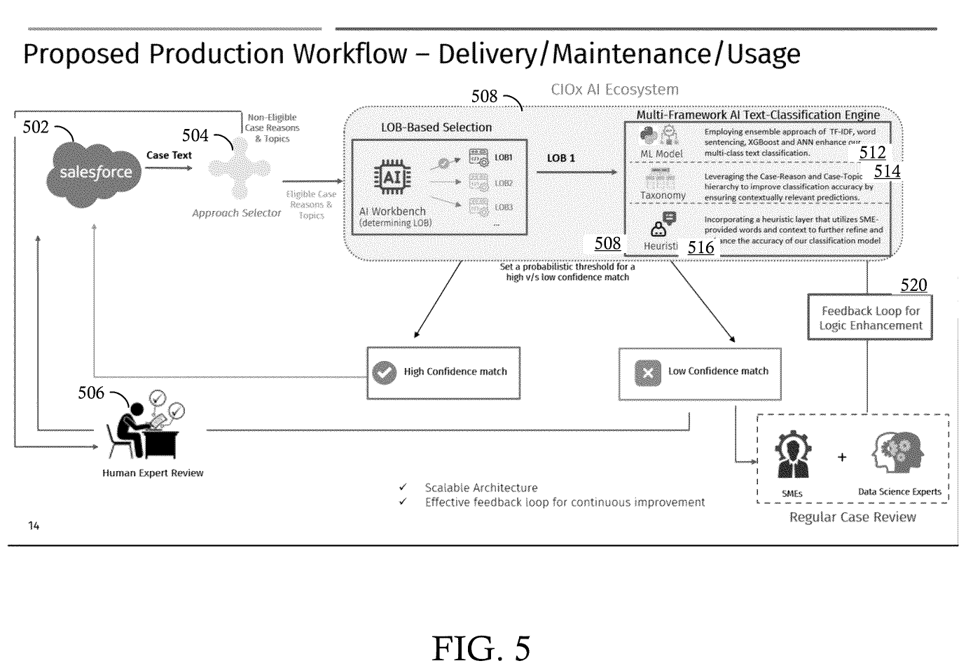

Turning now to FIG. 5, a flow diagram of a workflow for delivery, maintenance and usage, in accordance with one aspect of the present disclosure, is shown. Incoming messages are first received by customer relationship management (“CRM”) system 502. One example of a CRM system 502 is Salesforce. An incoming message may be received by CRM system 502 and then may be passed to approach selector 504. In some embodiments, approach selector 504 may determine whether the message is eligible for evaluation by the model. If not, it may be passed directly to manual review 506 by a human expert, who may then classify the message and then pass it back to CRM system 502 for assignment without the use of the AI model. Approach selector 504 may determine whether a message is eligible or ineligible based on a determined topic or case reason.

For messages that are selected for review by the model, by approach selector 504, the message may be sent for NLP by artificial intelligence ecosystem 508, as discussed above. In some organizations, different business units may have different criteria or requirements. Accordingly, in some embodiments, a first step may be to analyze the text to select the line of business (“LOB”). In some embodiments, a multi framework AI text classification engine 510 is invoked to analyze the text of the message. In some embodiments, classification engine 510 may include different classification models for different LOBs. In some embodiments, classification engine 510 may include three elements. A machine learning (“ML”) model 512 may employ ensemble approach of TF-IDF, word sentencing, XGBoost, and ANN, to enhance multi-class text classification. Classification engine 510 may also include taxonomy 514, which uses rule-based criteria. Taxonomy 514 may also leverage the case-reason and case-topic hierarchy, to improve classification accuracy by ensuring contextually relevant predictions. Taxonomy 514 may include guidance for how different keywords may come together in a specific way to create a category.

Classification engine 510 may also include heuristic layer 516, which may utilize words and context to further refine and enhance the accuracy of the classification model. Words and context may be provided by subject matter experts. For low confidence edge cases on the collective basis, human experts may be consulted and actually update CRM system 502 manually.

The system may also include a feedback loop 520, which may include input to the system from a regular case review, e.g. by data science experts and subject matter experts. In some embodiments, manual feedback may be combined with additional textual analysis. This may permit the model to learn which kinds of keyword sets are causing it to deliver incorrect results, and may update its criteria for classification based on examples of incorrect answers. ML model 512, taxonomy 514, and heuristics 516 can all be updated for more accurate results based on feedback loop 520.

It will be appreciated that determinations as disclosed herein, particularly on large datasets intended to be used with the disclosed embodiments/to generate trained models used in the disclosed embodiments, is only possible with the aid of computer-assisted machine-learning algorithms and techniques, such as TF-IDF, XG Boost, sentence embedding, and a neural network. In some embodiments, machine learning processes including TF-IDF, XG Boost, sentence embedding, and a neural network are used to perform operations that cannot practically be performed by a human, either mentally or with assistance, such as system and method for classifying incoming messages. It will be appreciated that a variety of machine learning techniques can be used alone or in combination to classify incoming messages.

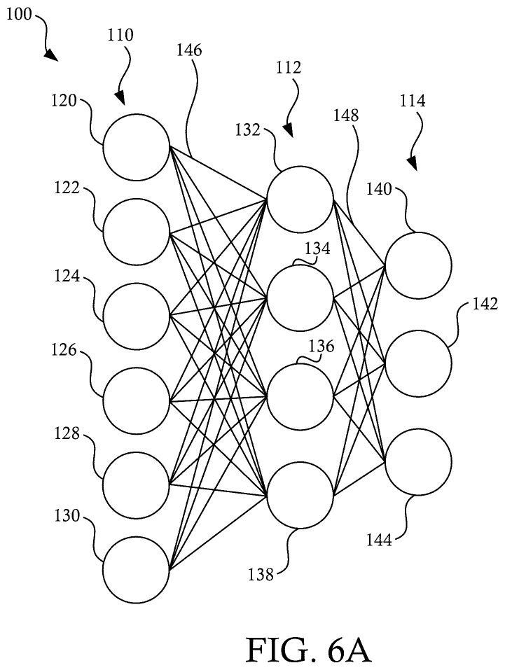

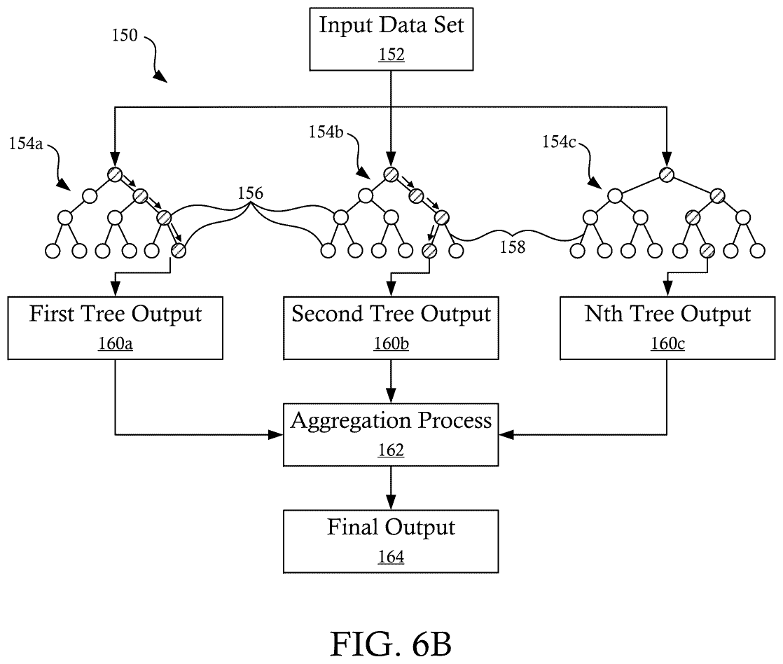

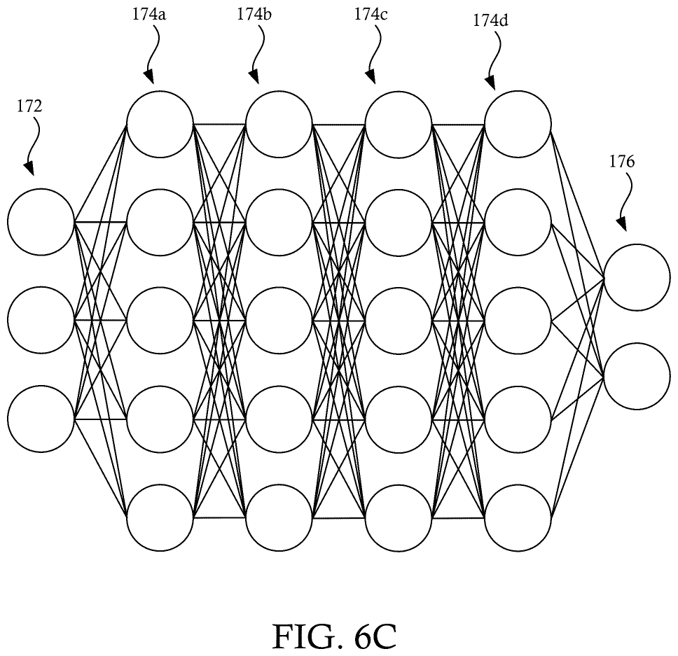

FIG. 6A illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 3 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 may be arranged in layers 110-114, wherein the layers may comprise an intrinsic order introduced by the edges 146-148 between the nodes 120-144 such that edges 146-148 exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 may be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number may be assigned as a value to every node 120-144 of the neural network 100. Here,

$${x}_{i}^{( n )}$$

denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 may comprise a weight being a real number, in particular, the weight is a real number within the interval [−1, 1], within the interval [0, 1], and/or within any other suitable interval. Here,

$${w}_{i , j}^{( m , n )}$$

denotes the weight of the edge between the i-th node 120-138 of the m-th layer 110, 112 and the j-th node 132-144 of the n-th layer 112, 114. Furthermore, the abbreviation

$${w}_{i , j}^{( n )}$$

is defined tor the weight

$${w}_{i , j}^{( m , n + 1 )} .$$

In particular, to calculate the output values of the neural network 100, the input values are propagated through the neural network. In particular, the values of the nodes 132-144 of the (n+1)-th layer 112, 114 may be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( m , n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 may be calculated based on the values of the input layer 110 of the neural network and/or based on the values of a prior hidden layer, etc.

In order to set the values

$${w}_{i , j}^{( m , n )}$$

for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${{w}^{′}}_{i , j}^{( m , n )} = {w}_{i , j}^{( m , n )} - γ \cdot {δ}_{j}^{( n )} \cdot {x}_{i}^{( n )}$$

wherein γ is a learning rate, and the numbers δⱼ⁽ⁿ⁾ may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( m , n )} )$$

based on

$${δ}_{j}^{( n + 1 )} ,$$

if the (n+1)-th layer is not the output layer, and

$${δ}_{j}^{( n )} ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( m , n )} )$$

if the (n+1)-th layer is the output layer 114, wherein f is the first derivative of the activation function, and

$${y}_{j}^{( n + 1 )}$$

is the comparison training value for the j-th node of the output layer 114.

FIG. 6B illustrates a tree-based neural network 150, in accordance with some embodiments. In particular, the tree-based neural network 150 is a random forest neural network, though it will be appreciated that the discussion herein is applicable to other decision tree neural networks. The tree-based neural network 150 includes a plurality of trained decision trees 154a-154c each including a set of nodes 156 (also referred to as “leaves”) and a set of edges 158 (also referred to as “branches”).

Each of the trained decision trees 154a-154c may include a classification and/or a regression tree (CART). Classification trees include a tree model in which a target variable may take a discrete set of values, e.g., may be classified as one of a set of values. In classification trees, each leaf 156 represents class labels and each of the branches 158 represents conjunctions of features that connect the class labels. Regression trees include a tree model in which the target variable may take continuous values (e.g., a real number value).

In operation, an input data set 152 including one or more features or attributes is received. A subset of the input data set 152 is provided to each of the trained decision trees 154a-154c. The subset may include a portion of and/or all of the features or attributes included in the input data set 152. Each of the trained decision trees 154a-154c is trained to receive the subset of the input data set 152 and generate a tree output value 160a-160c, such as a classification or regression output. The individual tree output value 160a-160c is determined by traversing the trained decision trees 154a-154c to arrive at a final leaf (or node) 156.

In some embodiments, the tree-based neural network 150 applies an aggregation process 162 to combine the output of each of the trained decision trees 154a-154c into a final output 164. For example, in embodiments including classification trees, the tree-based neural network 150 may apply a majority-voting process to identify a classification selected by the majority of the trained decision trees 154a-154c. As another example, in embodiments including regression trees, the tree-based neural network 150 may apply an average, mean, and/or other mathematical process to generate a composite output of the trained decision trees. The final output 164 is provided as an output of the tree-based neural network 150.

FIG. 6C illustrates a deep neural network (DNN) 170, in accordance with some embodiments. The DNN 170 is an artificial neural network, such as the neural network 100 illustrated in conjunction with FIG. 3, that includes representation learning. The DNN 170 may include an unbounded number of (e.g., two or more) intermediate layers 174a-174d each of a bounded size (e.g., having a predetermined number of nodes), providing for practical application and optimized implementation of a universal classifier. Each of the layers 174a-174d may be heterogenous. The DNN 170 may be configured to model complex, non-linear relationships. Intermediate layers, such as intermediate layer 174c, may provide compositions of features from lower layers, such as layers 174a, 174b, providing for modeling of complex data.

In some embodiments, the DNN 170 may be considered a stacked neural network including multiple layers each configured to execute one or more computations. The computation for a network with L hidden layers may be denoted as:

$$f ( x ) = f [ {a}^{( L + 1 )} ( {h}^{( L )} ( {a}^{( L )} ( ⋯ ( {h}^{( 2 )} ( {a}^{( 2 )} ( {h}^{( 1 )} ( {a}^{( 1 )} ( x ) ) ) ) ) ) ) ) ]$$

where a^{(l)}(x) is a preactivation function and h^{(l)}(x) is a hidden-layer activation function providing the output of each hidden layer. The preactivation function a^{(l)}(x) may include a linear operation with matrix W^{(l)} and bias b^{(l)}, where:

$${a}^{( l )} ( x ) = {W}^{( l )} x + {b}^{( l )}$$

In some embodiments, the DNN 170 is a feedforward network in which data flows from an input layer 172 to an output layer 176 without looping back through any layers. In some embodiments, the DNN 170 may include a backpropagation network in which the output of at least one hidden layer is provided, e.g., propagated, to a prior hidden layer. The DNN 170 may include any suitable neural network, such as a self-organizing neural network, a recurrent neural network, a convolutional neural network, a modular neural network, and/or any other suitable neural network.

In some embodiments, a DNN 170 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + ⋯ + {f}_{K} ( {x}_{K} )$$

where β is an offset and each fᵢ is parametrized by a neural network. In some embodiments, the DNN 170 may include a neural multiplicative model (NMM), including a multiplicative form for the NAM mode using a log transformation of the dependent variable y and the independent variable x:

$$y = {e}^{β} {e}^{f ( log x )} {e}^{{\sum }_{i} {f}_{i}^{d} ( {d}_{i} )}$$

where d represents one or more features of the independent variable x.

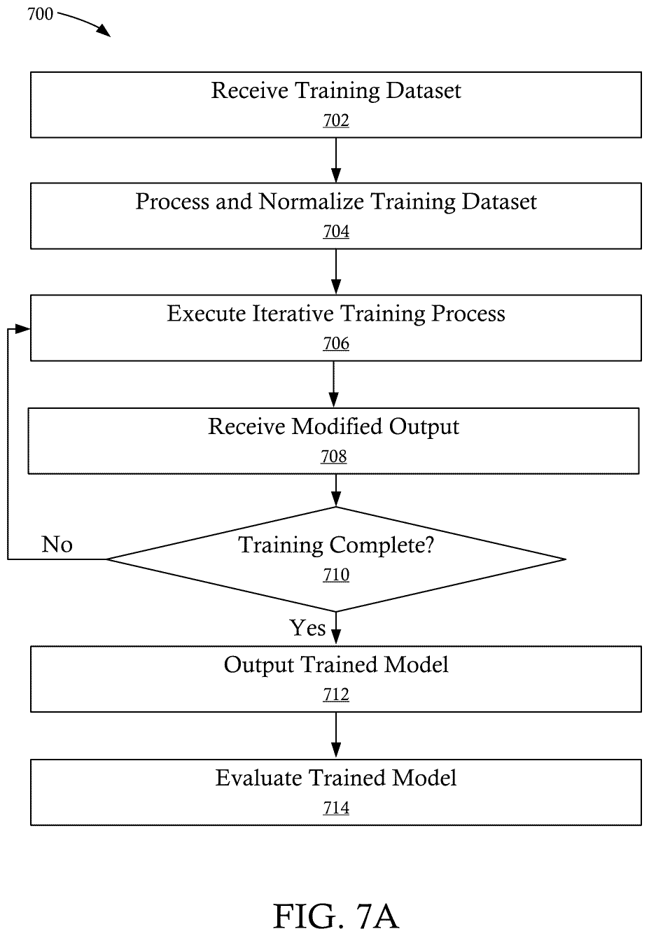

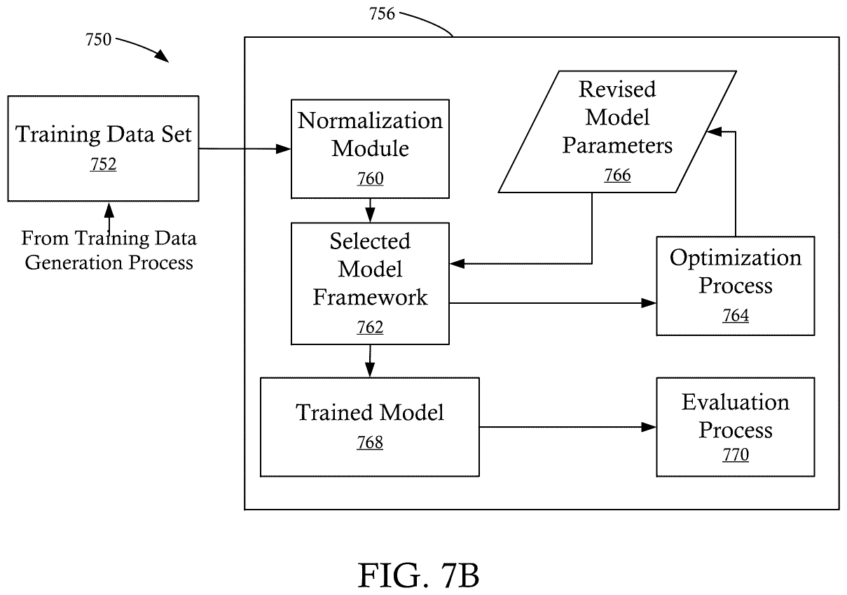

In some embodiments, a message classification model can include and/or implement one or more trained models, such as a sentence embedding. In some embodiments, one or more trained models can be generated using an iterative training process based on a training dataset. FIG. 7A illustrates a method 700 for generating a trained model, such as a trained system and method for classifying incoming messages model, in accordance with some embodiments. FIG. 7B is a process flow 750 illustrating various steps of the method 700 of generating a trained model, in accordance with some embodiments. At step 702, a training dataset 752 is received by a system, such as a processing device 10. The training dataset 752 can include labeled and/or unlabeled data. For example, in some embodiments, a set of correctly categorized incoming messages is provided for use in training a model.

At optional step 704, the received training dataset 752 is processed and/or normalized by a normalization module 760. For example, in some embodiments, the training dataset 752 can be augmented by imputing or estimating missing values of one or more features associated with keyword sets or other model inputs. In some embodiments, processing of the received training dataset 752 includes outlier detection configured to remove data likely to skew training of commonly misclassified messages. In some embodiments, processing of the received training dataset 752 includes removing features that have limited value with respect to training of the message classification model.

At step 706, an iterative training process is executed to train a selected model framework 762. The selected model framework 762 can include an untrained (e.g., base) machine learning model, such as TF-IDF, sentence embeddings, XGBoost, or deep learning ANN and/or a partially or previously trained model (e.g., a prior version of a trained model). The training process is configured to iteratively adjust parameters (e.g., hyperparameters) of the selected model framework 762 to minimize a cost value (e.g., an output of a cost function) for the selected model framework 762. In some embodiments, the cost value is related to labor intensive document classifications.

The training process is an iterative process that generates set of revised model parameters 766 during each iteration. The set of revised model parameters 766 can be generated by applying an optimization process 764 to the cost function of the selected model framework 762. The optimization process 764 can be configured to reduce the cost value (e.g., reduce the output of the cost function) at each step by adjusting one or more parameters during each iteration of the training process.

After each iteration of the training process, at step 708, a determination is made whether the training process is complete. The determination at step 708 can be based on any suitable parameters. For example, in some embodiments, a training process can complete after a predetermined number of iterations. As another example, in some embodiments, a training process can complete when it is determined that the cost function of the selected model framework 762 has reached a minimum, such as a local minimum and/or a global minimum.

At step 710, a trained model 768, such as a trained sentence embedding model, is output and provided for use in a method of classifying messages, such as the method of classifying messages 200 discussed above with respect to FIGS. 3-5. At optional step 712, a trained model 768 can be evaluated by an evaluation process 770. A trained model can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

Although the subject matter has been described in terms of exemplary embodiments, it is not limited thereto. Rather, the appended claims should be construed broadly, to include other variants and embodiments, which may be made by those skilled in the art.

What is claimed is:

1. A system for automatically categorizing an incoming electronic message using natural language processing to generate an input for a machine learning classification model, comprising:
a non-transitory memory;
a processor communicatively coupled to the non-transitory memory, wherein the processor is configured to read a set of instructions to:
receive an incoming message, the incoming message having a first text field containing sender identifying information, a second text field containing a subject, and a third text field containing a body;
determine whether the incoming message can be categorized based on the sender identifying information;
upon a determination that the incoming message can be categorized based on the sender identifying information, categorize the incoming message based on the sender identifying information;
upon a determination that the incoming message cannot be categorized based on the sender identifying information:
tokenize the second text field and the third text field into a plurality of textual units;
vectorize, by a natural language processing model, the plurality of textual units into numerical representations for analysis and pattern recognition, wherein the vectorizing includes using the natural language processing model to evaluate words and sentence embeddings to determine a relative importance; and
evaluate the vectorized textual units, using a machine learning model, to classify the incoming message into a classification, the classification having a case reason and a case topic.

2. The system of claim 1, wherein the machine learning model is a neural network model.

3. The system of claim 1, wherein vectorizing the plurality of textual units includes evaluating a plurality of keywords contained in the third text field.

4. The system of claim 3, wherein evaluating the vectorized textual units further comprises evaluating a position of one of the plurality of keywords, relative to a position of another of the plurality of keywords.

5. The system of claim 1, wherein the natural language processing model includes a Term Frequency-Inverse Document Frequency (“TF-IDF”) vectorization process.

6. The system of claim 1, wherein the machine learning model comprises an ensemble model including one or more of a Term Frequency-Inverse Document Frequency (“TF-IDF”) framework, a word sentencing framework, an XGBoost framework, an ANN framework, or any combination thereof.

7. The system of claim 1, wherein the processor is configured to read the set of instructions to:
determine a probability that the incoming message has been classified correctly;
upon a determination that the probability is below a threshold, tag the incoming message for further evaluation of the classification;
upon a determination that the probability is above the threshold, categorize the incoming message and tag the incoming message for further action relating to the classification.

8. The system of claim 7, wherein the second text field is tokenized into a plurality of subject-field textual units, wherein the third text field is tokenized into a plurality of body textual units, and wherein the subject-field textual units are vectorized, evaluated using the machine learning model to classify the incoming message into the classification, determining the probability that the incoming message has been classified correctly, and, upon a determination that the probability is below a threshold, vectorizing the body textual units, evaluating the body textual units using the machine learning model to classify the incoming message into the classification, and determining the probability that the incoming message has been classified correctly.

9. A computer-implemented method for automatically categorizing an incoming electronic message using natural language processing to generate an input for a machine learning classification model, comprising:
receiving an incoming message, the incoming message having a first text field containing sender identifying information, a second text field containing a subject, and a third text field containing a body;
determining whether the incoming message can be categorized based on the sender identifying information;
upon a determination that the incoming message can be categorized based on the sender identifying information, categorizing the incoming message based on the sender identifying information;
upon a determination that the incoming message cannot be categorized based on the sender identifying information:
tokenizing the second text field and the third text field into a plurality of textual units;
vectorizing, by a natural language processing model, the plurality of textual units into numerical representations for analysis and pattern recognition, wherein the vectorizing includes using the natural language processing model to evaluate words and sentence embeddings to determine a relative importance; and
evaluating the vectorized textual units, using a machine learning model, to classify the incoming message into a classification, the classification having a case reason and a case topic.

10. The computer-implemented method of claim 9, wherein the machine learning model is a neural network model.

11. The computer-implemented method of claim 9, wherein vectorizing the plurality of textual units includes evaluating a plurality of keywords contained in the third text field.

12. The computer-implemented method of claim 11, wherein evaluating the vectorized textual units further comprises evaluating a position of one of the plurality of keywords, relative to a position of another of the plurality of keywords.

13. The computer-implemented method of claim 9, wherein the natural language processing model includes a Term Frequency-Inverse Document Frequency (“TF-IDF”) vectorization process.

14. The computer-implemented method of claim 9, wherein the machine learning model comprises an ensemble model including one or more of a Term Frequency-Inverse Document Frequency (“TF-IDF”) framework, a word sentencing framework, an XGBoost framework, an ANN framework, or any combination thereof.

15. The computer-implemented method of claim 9, comprising:
determining a probability that the incoming message has been classified correctly;
upon a determination that the probability is below a threshold, tagging the incoming message for further evaluation of the classification;
upon a determination that the probability is above the threshold, categorizing the incoming message and tag the incoming message for further action relating to the classification.

16. The computer-implemented method of claim 9, wherein the second text field is tokenized into a plurality of subject-field textual units, wherein the third text field is tokenized into a plurality of body textual units, and wherein the subject-field textual units are vectorized, evaluated using the machine learning model to classify the incoming message into the classification, determining the probability that the incoming message has been classified correctly, and, upon a determination that the probability is below a threshold, vectorizing the body textual units, evaluating the body textual units using the machine learning model to classify the incoming message into the classification, and determining the probability that the incoming message has been classified correctly.

17. A non-transitory computer readable medium having instructions stored thereon for automatically categorizing an incoming electronic message using natural language processing to generate an input for a machine learning classification model, wherein the instructions, when executed by at least one processor, cause at least one device to perform operations comprising:
receiving an incoming message, the incoming message having a first text field containing sender identifying information, a second text field containing a subject, and a third text field containing a body;
determining whether the incoming message can be categorized based on the sender identifying information;
upon a determination that the incoming message can be categorized based on the sender identifying information, categorizing the incoming message based on the sender identifying information;
upon a determination that the incoming message cannot be categorized based on the sender identifying information:
tokenizing the second text field and the third text field into a plurality of textual units;
vectorizing, by a natural language processing model, the plurality of textual units into numerical representations for analysis and pattern recognition, wherein the vectorizing includes using the natural language processing model to evaluate words and sentence embeddings to determine a relative importance; and
evaluating the vectorized textual units, using a machine learning model, to classify the incoming message into a classification, the classification having a case reason and a case topic.

18. The non-transitory computer readable medium of claim 17, wherein the machine learning model is a neural network model.

19. The non-transitory computer readable medium of claim 17, wherein vectorizing the plurality of textual units includes evaluating a plurality of keywords contained in the third text field.

20. The non-transitory computer readable medium of claim 19, wherein evaluating the vectorized textual units further comprises evaluating a position of one of the plurality of keywords, relative to a position of another of the plurality of keywords.
